(19) United States
(12) Patent Application Publication
(10) Pub. No.: US 2011/0220134 A1
(43) Pub. Date: Sep. 15, 2011

(54) Filter For A Smoking Article

(76) Inventors: Martin Duke, London (GB); Paulo Oliveira, London (GB)

(21) Appl. No.: 13/119,417

(22) PCT Filed: Sep. 10, 2009
(86) PCT No.: PCT/GB09/51158

§ 371 Date: May 31, 2011

(30) Foreign Application Priority Data
Sep. 16, 2008 (GB) 0816937.7

(51) Int. Cl. A24D 3/06; A24F 47/00; B32B 37/00; B31C 99/00

(52) U.S. Cl. 131/331; 131/347; 156/166; 493/39

(57) ABSTRACT

The invention provides a filter element for a smoking article. The filter element comprises a plug of filter material, and a thread comprising at least one tobacco particle adhered thereto, wherein the thread extends substantially longitudinally through the plug of filter material. The filter element can be used in a variety of smoking articles.

The present invention relates to filters for smoking articles.

It is well known that filtration of smoke in a smoking article, such as a cigarette may affect the taste and flavour characteristics of a product when smoked. Filters commonly include adsorbent materials, such as activated carbon, to reduce certain components of the smoke during smoking. However, activated carbon in a filter can adversely affect the taste and/or flavour characteristics of a cigarette.

Therefore, in a first aspect, there is provided a filter element for a smoking article, the filter element comprising a plug of filter material, and a thread comprising at least one tobacco particle adhered thereto, wherein the thread extends substantially longitudinally through the plug of filter material.

The inventors have found that the provision of the substantially longitudinal thread comprising at least one particle of tobacco adhered thereto significantly improves the flavour of smoke (which comprises gas and particulate matter) that is inhaled by a smoker.

Preferably, the thread extends substantially longitudinally between mutually opposing end faces of the plug of filter material. Preferably, the thread extends in a direction which is substantially parallel to a side face of the plug of filter material, which side face is preferably substantially perpendicular to one or both end faces. Preferably, the thread extends through an inner portion of, and is surrounded by, the filter material. Preferably, the thread extends through substantially the centre of the plug of filter material.

Advantageously, the thread is disposed in close proximity with the path of the gaseous flow as it moves through the filter element, and is therefore able to affect various characteristics of the gaseous flow before the flow reaches the smoker's mouth. Furthermore, because the thread is disposed substantially longitudinally within the plug of filter material, it does not adversely affect the direction or rate of gaseous flow, and so the smoker does not detect a significant difference in resistance to draw through the filter.

The thread may be made of a material which is substantially filamentous. It is preferred that the thread is made of a non-toxic material, which is suitable for use in a smoking article filter. For example, the thread may comprise material selected from a group consisting of cotton, filter material (eg. cellulose acetate), alginate, wool, cellulose fibre, and viscose fibre. Preferably, the thread comprises cotton. Preferably, the thread is not made of tobacco.

The thread may be between 0.2 mm and 5 mm in diameter, preferably between 0.4 mm and 3 mm in diameter, more preferably between 0.5 mm and 2 mm in diameter.

The at least one particle of tobacco adhered to the thread may comprise shredded tobacco, powdered tobacco, tobacco fibres, tobacco sheet and/or reconstituted tobacco. Preferably, the particulate tobacco comprises tobacco that has been cut to a particular size. The at least one particle of tobacco may have an average length which is substantially equivalent to the length of the plug of filter material.

However, it is preferred that the thread comprises a plurality of tobacco particles adhered thereto. For example, the or each tobacco particle may have an average length of between 0.1 mm to 10 mm, preferably between 0.5 mm and 4 mm.

The at least particle of tobacco may cover substantially all of the outer surface of the thread. Hence, it is preferred that the at least one particle, and preferably plurality of particles, provide a coating on substantially the entire surface of the thread. However, in another embodiment, the plurality of tobacco particles may be spaced apart along the outer surface of the thread. The spacing between adjacent particles of tobacco on the surface of the thread may be between 0.1 mm to 3 mm, preferably between 0.2 mm and 2 mm, more preferably between 0.3 mm and 1 mm, and most preferably between 0.4 mm and 0.8 mm.

The at least one particle of tobacco may be adhered to, or attached to, the thread by adhesive. For example, the thread may be contacted with adhesive, which may be provided in a first container (eg. a bath of adhesive). The thread may then be contacted with at least one particle of tobacco, which may be provided in a second container (eg. a tobacco bath). Hence, by passing the thread first through the adhesive bath and then the tobacco bath, a coating of tobacco is formed on the outer surface of the thread.

In some embodiments, instead of using adhesive, the thread may be wetted, for example with water, prior to contacting with the tobacco.

In another embodiment, the at least one particle of tobacco may be adhered to the thread by (i) contacting said thread with a solution comprising at least one particle of tobacco, and (ii) allowing the thread to dry, such that the tobacco particle adheres to the surface of the thread. A slurry comprising a plurality of tobacco particles (e.g. tobacco dust and/or tobacco stems etc.), may be prepared, which slurry may further comprise a suitable binding agent. Preferably, the slurry is then contacted with the thread (e.g. cotton), under conditions suitable to allow at least one tobacco particle, and preferably a plurality of tobacco particles, to become adhered to the surface of the thread. The thread comprising particulate tobacco thereon may then be allowed to dry, or heated, for example by an oven, such that the tobacco adheres to the surface of the thread. The thread may then be used to form the filter element of the first aspect.

The concentration of tobacco that is adhered to the thread may depend on the diameter or thickness of the thread. Hence, by way of example only, in an embodiment where the diameter of the thread is 2 mm, the tobacco loading may be between about 0.1 mg to 20 mg per mm of thread length, preferably between about 0.2 mg to 10 mg per mm of thread length, and more preferably between about 0.5 mg and 2 mg per mm of thread length.

Once prepared, the thread comprising at least one tobacco particle may then be encased by filter material to form the filter element of the first aspect. The plug of filter material may comprise any suitable filter media, which will be known to the skilled technician. A preferred filter material comprises cellulose acetate. The diameter of the plug of filter material may be between 5 mm and 15 mm, preferably between 6 mm and 12 mm, more preferably between 7 mm and 11 mm, and most preferably between 8 mm and 10 mm.

Preferably, the ratio of the diameter of the plug of filter material to the diameter of the thread comprising particulate tobacco is between 2:1 and 25:1, more preferably between 4:1 and 10:1.

The filter element may comprise a flavourant. In embodiments where a flavourant is used, the flavourant may be incorporated in the plug of filter material. However, preferably the flavourant is incorporated in the thread comprising particulate tobacco. Flavour may be added to the adhesive, directly to the thread, or to the tobacco. For example, once formed, the thread may be dipped into a vessel containing the flavourant.

It will be appreciated that the filter element according to the first aspect may be used in the manufacture of a filter, for use in a smoking article.

Hence, according to a second aspect of the invention, there is provided a filter for a smoking article, the filter comprising a filter element according to the first aspect.

The filter of the second aspect may comprise a plurality of filter elements according to the first aspect, in which a thread comprising a tobacco particle extends through a plug of filter material. For example, the filter may comprise 2, 3, 4, 5 or more filter elements of the first aspect, in which adjacent filter elements may either be connected to each other, or which elements may be separated from each other by other filter elements (which may not be in accordance with the first aspect).

Hence, the filter may comprise a plurality of filter elements, at least one of which is a filter element according to the first aspect of the invention. For example, it is envisaged that, in one embodiment, in addition to comprising one or more filter elements according to the first aspect (ie. containing the particulate tobacco-containing thread), the filter of the second aspect may also comprise an adsorbent filter element, which element comprises an adsorbent material. The adsorbent filter element is provided to adsorb and, hence, reduce certain components of the smoke during smoking. The adsorbent filter element may comprise a plug of filter material in which the adsorbent material is dispersed. The filter material may be cellulose acetate. A preferred adsorbent material is activated carbon. The activated carbon may be in the form of granular activated carbon, which is preferably distributed substantially throughout the volume of the plug of filter material. Preferably, the adsorbent filter element does not include a tobacco thread.

In another embodiment, in addition to comprising one or more filter elements according to the first aspect (ie. containing the particulate tobacco-containing thread), the filter of the second aspect may also comprise a filter element, which comprises filter material (such as, cellulose acetate), and which does not include a tobacco thread or adsorbent material.

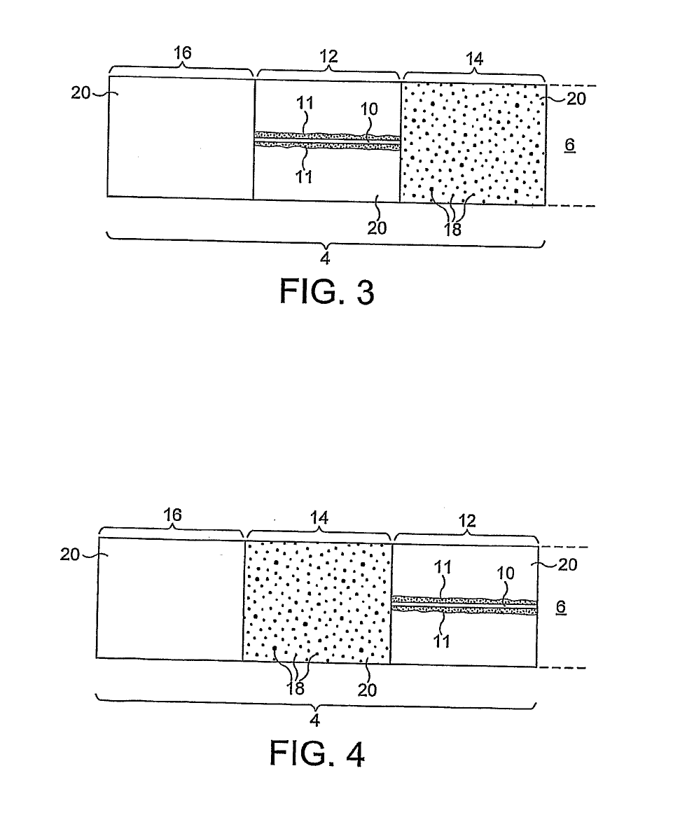

The filter may comprise at least two, and preferably at least three filter elements, provided that at least one filter element is in accordance with the first aspect. Preferably, the filter comprises a filter element according to the first aspect, an adsorbent filter element comprising adsorbent, and a filter element, which does not include adsorbent or a tobacco thread. Preferably, multiple filter elements are arranged longitudinally of one another with the end face of one filter element abutting the end face of an adjacent filter element. It is preferred that the filter elements have substantially similar diameters. It should be appreciated that the various filter elements may be in any order in the filter, as illustrated in FIGS. 3 and 4.

The filter element of the first aspect, or the filter of the second aspect, may be incorporated into a smoking article.

Hence, according to a third aspect of the invention, there is provided a smoking article comprising a filter element according to the first aspect, or a filter according to the second aspect.

The smoking article preferably comprises a section of smokeable material, such as tobacco. As used herein, the term “smoking article” includes smokeable products such as cigarettes, cigars and cigarillos whether based on tobacco, tobacco derivatives, expanded tobacco, reconstituted tobacco or tobacco substitutes and also heat-not-burn products.

The section of smokeable material and the filter may be attached by tipping paper.

According to a fourth aspect of the invention, there is provided a method of manufacturing a filter element for a smoking article, the method comprising providing a thread comprising at least one tobacco particle adhered thereto through a plug of filter material, wherein the thread extends substantially longitudinally through the plug of filter material.

Preferably, the thread is a non-tobacco thread (e.g. cotton). Preferably, the method comprises initially attaching at least one tobacco particle to the thread, and preferably attaching a plurality of tobacco particles to the thread. Preferably, the method comprises (i) contacting the thread with a solution comprising at least one particle of tobacco, and (ii) allowing the thread to dry, such that the tobacco particle adheres to the surface of the thread. In some embodiments, it may be desirable to use an adhesive. Hence, the method may comprise (i) contacting the thread with adhesive, and then (ii) contacting the thread with tobacco particles. Preferably, the method comprises passing the thread through a container of adhesive and then through a container of tobacco particles, such that tobacco particle(s) adhere to the thread.

The method preferably comprises a step of introducing the thread comprising at least one tobacco particle into substantially the centre of the filter material. The method may comprise using guide means to guide the thread as a tow of filter material is formed therearound. The guide means may comprise a guide tube through which the thread is entrained. As the thread exits the guide means, it is preferably surrounded by filter material.

The inventors believe that the thread comprising the particulate tobacco adhered thereto may have significant utility in the manufacture of filters for smoking articles.

Hence, in a fifth aspect, there is provided a thread comprising at least one piece of particulate tobacco adhered thereto.

The thread of the fifth aspect is preferably as is defined in accordance with the first aspect of the invention. Preferably, the thread comprises a non-toxic material. Preferably, the thread is suitable for use in the manufacture of a smoking article filter. Preferably, the thread comprises cotton. The thread may be between 0.2 mm and 5 mm, and most preferably between 0.5 mm and 2 mm in diameter. The at least one particle of tobacco adhered to the thread may comprise shredded tobacco, powdered tobacco, tobacco fibres, tobacco sheet and/or reconstituted tobacco. It is preferred that the thread comprises a plurality of tobacco particles adhered thereto. For example, the or each tobacco particle may have an average length of between 0.1 mm to 10 mm, and most preferably between 0.5 mm and 4 mm.

All of the features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention, and to show how embodiments of the same may be carried into effect, reference will now be made, by way of example, to the accompanying Figures, in which:—

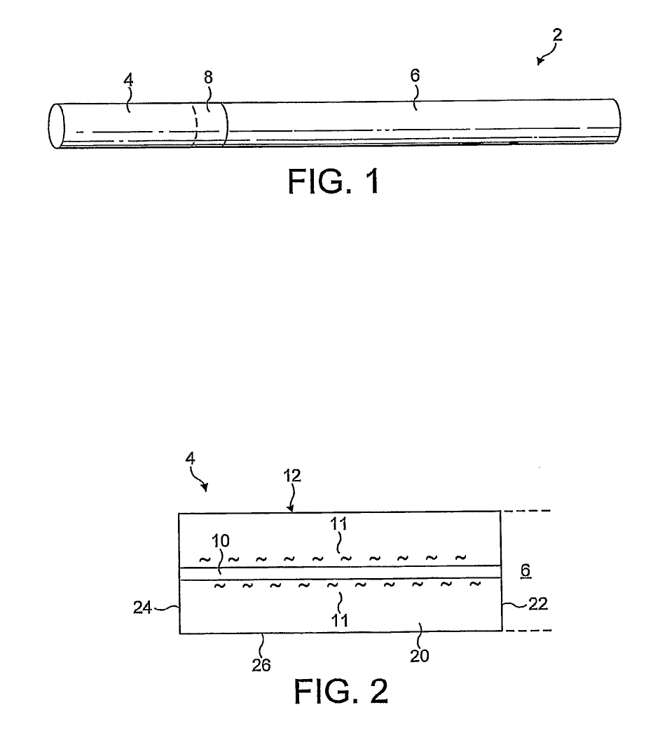

FIG. 1 shows a perspective view of a smoking article, including a rod of smokeable material, a filter in accordance with the invention, and tipping paper attaching the rod and filter together;

FIG. 2 shows a cross-sectional side view of a first embodiment of the filter according to the invention;

FIG. 3 shows a cross-sectional side view of a second embodiment of the filter; and

FIG. 4 shows a cross-sectional side view of a third embodiment of the filter.

Referring to FIG. 1, there is shown a smoking article 2, in the form of a cigarette, which includes a filter 4 in accordance with the invention. Even though the Figures show the smoking article 2 as a cigarette, it should be appreciated that the smoking article 2 may take other forms, such as cigars and cigarillos etc, which may also include the filter 4 according to the invention. Referring to FIG. 1, the smoking article 2 comprises a generally cylindrical paper-wrapped rod 6 of smokeable material, such as tobacco, which is co-axially attached to the filter 4 by tipping paper 8, which is glued around one end of the rod 6 and the filter 4.

Referring to FIG. 2, there is shown a first embodiment of the filter 4 attached to the rod of tobacco 6. In this embodiment, the filter 4 is made up of a single, filter element 12 about 27 mm in length, which consists of a continuous plug of filter material 20 (for example, cellulose acetate) having a diameter of 9 mm. The filter element 12 has first and second generally circular end faces 22, 24, and a circumferential or longitudinally extending side surface 26 substantially perpendicular to the first and second end faces 22, 24. As shown in FIG. 2, a thin cotton thread 10 having a diameter of 0.8 mm having particles of tobacco 11 attached thereto extends between the two end faces 22, 24 through the plug of filter material 20. The average length of tobacco particles 11 attached to the thread 10 is about 1.5 mm.

The tobacco particles 11 can be attached to the thread 10 by adhesive. For example, the thread 10 is first passed through a reservoir or bath of adhesive (not shown). The thread 10 is then be passed through a bath containing tobacco particles 11 (not shown) In some embodiments, instead of using adhesive, the thread 10 may be wetted by passing it through a water both (not shown), prior to passing it through the bath containing tobacco particles 11. In each case, the thread 10 is then allowed to dry (for example, by heating), such that the particles 11 become attached to the outer surface of the thread 10.

The resultant thread 10 is approximately 0.8 mm in diameter, which is then introduced into the centre of the filter material 20. The thread 10 is disposed such that it is substantially parallel with the longitudinally extending surface 26, and substantially through the centre of the plug of filter material 20, thereby forming a core. One method of introducing the tobacco thread 10 in to the plug of filter material 20 in the manufacture of the filter element 12 is as follows. The method involves entraining the tobacco-coated thread 10 through the lumen of a guide tube (not shown) having a diameter of about 1.5 mm. Simultaneously, a supply of fibrous filter material 20 (e.g. cellulose acetate) is passed through a series of blooming rollers so that it is de-crimped. A tow of de-crimped filter material 20 is then formed around the thread 10 as it exits the guide tube, to thereby form a continuous rod of filter material 20 enclosing the thread 10. The rod may then be cut up in to sections to produce the completed filter element 12 as shown in FIG. 2. The length of the filter element 12 will depend on the type of filter 4 required. For example, a standard cigarette filter 4 is about 27 mm in length. In the embodiment shown in FIG. 2, the whole 27 mm length of the filter 4 consists of the filter element 12, such that the thread 10 extends all the way along. However, FIGS. 3 and 4 illustrate other embodiments, in which the filter 4 comprises a shorter section of the filter element 12 containing the thread 10 in combination with other sections, as described below.

Referring to FIG. 3, there is a shown a second embodiment of the filter 4 attached to the rod of tobacco 6. The filter 4 comprises a plurality of different discrete filter elements 12, 14, 16, each of which may have a different material composition. In this embodiment, the filter 4 includes three different filter elements 12, 14, 16. Each filter element 12, 14, 16 is generally cylindrical in shape having substantially equivalent diameters. Each filter element 12, 12, 16 is wrapped by a layer of thin sheet material in the form of a wrapper, known as a plugwrap (not shown), which may be formed of conventional paper materials. The filter element 16 that is farthest from the tobacco rod 6 (and which will be closest to the smoker's mouth when in use) comprises a generally cylindrical tow of filter material 20, such as cellulose acetate. The filter material 20 provides a filter through which smoke may pass as a smoker inhales on the cigarette 2. The filter element 12 that is disposed adjacent element 16 contains a continuous plug of filter material 20 having the thread 10, with particulate tobacco 11 attached thereto, extending substantially longitudinally therethrough. This filter element 12 is similar to that shown in FIG. 1, except that it does not extend along the entire length of the filter 4.

The third filter element 14 that is disposed between the filter element 12 containing the thread 10 and the tobacco rod 6 comprises a plug of filter material 20, in which an adsorbent, such as activated carbon 18, has been dispersed. The activated carbon 18 may be in the form of granular activated carbon 18, which is distributed evenly throughout the volume of the plug of cellulose acetate 20 in a “Dalmatian” style, as is known in the art, and as shown in FIG. 3. Alternatively, the activated carbon 18 may be sprinkled onto a sticky exterior surface 26 of the plug of cellulose acetate 20, or may be adhered to the inner surface of the plugwrap surrounding the cellulose acetate, or may be adhered to a cotton thread surrounded by the plug of cellulose acetate 20 (not shown). The activated carbon 18 could also be held in a cavity surrounded by the plug of cellulose acetate 20. The activated carbon 18 is provided to improve the characteristics of the smoke that is inhaled by removing toxic chemicals.

Referring to FIG. 4, there is a shown a third embodiment of the filter 4 attached to the tobacco rod 6. In this embodiment, the filter 4 includes the same three filter elements 12, 14, 16 as in the second embodiment, as described above, except that the order of the elements has been changed. As shown in FIG. 4, the filter element 16 that is farthest from the tobacco rod 6 comprises filter material 20, such as cellulose acetate, as in the second embodiment. However, in the third embodiment, the filter element 12 that is disposed adjacent element 16 contains a plug of filter material 20, in which particles of activated carbon 18 have been dispersed. Finally, the third filter element 12 disposed between element 14 and the rod of tobacco 6 contains a continuous plug of filter material 20 through which extends the cotton thread 10 with tobacco particles 11. Accordingly, the positions of filter elements 12, 14 have been swapped in the second and third embodiments.

As shown in FIGS. 3 and 4, the filter elements 12, 14, 16 are arranged longitudinally of one another with the end face 22, 24 of each filter element 12, 14, 16 abutting the next. Although the three filter elements 12, 14, 16 are shown in FIGS. 3 and 4 as being substantially equal in length, it will be appreciated that they could have different lengths. For example, in FIGS. 3 and 4, the filter element 12 containing the tobacco thread 10 could be 12 mm in length, and the other elements 14, 16 could be 7.5 mm each, such that the total length of the filter 4 is 27 mm. In addition, it will be appreciated that the filter 4 may comprise only the two filter elements. For example, the filter 4 may comprise the filter element 12 containing the tobacco thread 10 (about 15 mm long) and the filter element 16 containing only filter material 20 (about 12 mm long), in either order. Alternatively, the filter 4 may comprise the filter element 12 containing the thread 10 and the filter element 14 containing activated carbon 18, in either order.

Also, the filter 4 may comprise more than three filter elements 12, 14, 16. For example, the filter 4 may comprise first and second filter elements 16 composed of cellulose acetate, a third filter element 14 comprising cellulose acetate and activated carbon 18, and a fourth filter element 12 comprising the longitudinal thread 10 core, as described above. It will be appreciated that the various filter elements 12, 14, 16 may be arranged in the filter 4 in a variety of alternative orders. However, in each embodiment, at least one filter element 12 containing the thread 10 with tobacco particles 11 is included in the filter 4.

Referring to FIG. 1 once again, the filter 4 is located at a mouth-end of the smoking article 2 such that a gaseous flow, comprising smoke drawn from the rod 6 of smokeable material, moves through the filter 4 before entering the mouth of a smoker. The tobacco-covered thread 10 is located in one or more filter elements 12, and extends longitudinally between the end faces 22, 24 of a plug of filter material 20, as described in relation to FIG. 2. In this way, the thread 10 is disposed in close proximity with the path of the gaseous flow as it moves through the filter 4, and is therefore able to affect various characteristics of the gaseous flow before the flow reaches the smoker's mouth.

The tobacco-covered thread 10 may, for example, affect the overall properties of the gaseous flow such that the taste and flavour of the gaseous flow are improved. One application of the tobacco particles 11 on the thread 10 is to replace a degree of the taste and flavour characteristics of the gaseous flow which may be lost as the gaseous flow moves through the filter material 20, or the activated carbon 18, which is known to affect the taste and flavour of tobacco smoke. The inventors have surprisingly found that the arrangement of the thin thread 10 extending longitudinally through the plug of filter material 20 improves the flavour of the smoke without compromising the flow characteristics of the smoke.

The invention also includes further modifications and variations falling within the scope of the claims.

1. A filter element for a smoking article, the filter element comprising a plug of filter material, and a thread comprising at least one tobacco particle adhered thereto, wherein the thread extends substantially longitudinally through the plug of filter material.

2. The filter element according to claim 1, wherein the thread extends substantially longitudinally between mutually opposing end faces of the plug of filter material.

3. The filter element according to claim 2, wherein the thread extends in a direction which is substantially parallel to a side face of the plug of filter material, which side face is substantially perpendicular to one or both end faces.

4. The filter element according to claim 1, wherein the thread extends through an inner portion of, and is surrounded by, the filter material.

5. The filter element according to claim 1, wherein the thread extends through substantially the center of the plug of filter material.

6. The filter element according to claim 1, wherein the thread comprises material selected from a group consisting of cotton, filter material, alginate, wool, cellulose fibre, and viscose fibre.

7. The filter element according to claim 1, wherein the thread is between 0.2 mm and 5 mm in diameter.

8. The filter element according to claim 1, wherein the at least one particle of tobacco adhered to the thread comprises shredded tobacco, powdered tobacco, tobacco fibres, tobacco sheet or reconstituted tobacco.

9. The filter element according to claim 1, wherein the thread comprises a plurality of tobacco particles adhered thereto.

10. The filter element according to claim 9, wherein the tobacco particle has an average length of between 0.1 mm to 3 mm.

11. The filter element according to claim 1, wherein the at least one tobacco particle covers substantially all of the outer surface of the thread.

12. The filter element according to any one of claim 9, wherein the plurality of tobacco particles are spaced apart along the outer surface of the thread.

13. The filter element according to claim 1, wherein the at least one particle of tobacco is adhered to the thread by (i) contacting said thread with a solution comprising at least one particle of tobacco, and (ii) allowing the thread to dry, such that the tobacco particle adheres to the surface of the thread.

14. The filter element according to claim 1, wherein the filter material comprises cellulose acetate.

15. The filter element according to claim 1, wherein the diameter of the plug of filter material is between 5 mm and 15 mm.

16. The filter element according to claim 1, wherein the filter element comprise a flavourant.

17. A filter for a smoking article, the filter comprising the filter element according to claim 1.

18. The filter according to claim 17, wherein the filter comprises a plurality of filter elements, at least one of which is a filter element comprising a plug of filter material, and a thread comprising at least one tobacco particle adhered thereto, wherein the thread extends substantially longitudinally through the plug of filter material.

19. The filter according to claim 17, wherein the filter comprises an adsorbent filter element, which element comprises an adsorbent material.

20. The filter according to claim 19, wherein the adsorbent material is activated carbon.

21. The filter according to claim 17, wherein the filter also comprises the filter element, which comprises filter material (such as, cellulose acetate), and which does not include a thread with tobacco particles, or adsorbent material.

22. A smoking article comprising the filter element according claim 1.

23. A method of manufacturing a filter element for a smoking article, the method comprising providing a thread comprising at least one tobacco particle adhered thereto through a plug of filter material, wherein the thread extends substantially longitudinally through the plug of filter material.

24. The method according to claim 23, wherein the method comprises initially attaching at least one tobacco particle to the thread.

25. The method according to claim 24, wherein the method comprises (i) contacting the thread with a solution comprising at least one particle of tobacco, and (ii) allowing the thread to dry, such that the tobacco particle adheres to the surface of the thread.

26. The method according to claim 23, wherein the method comprises passing the thread through a container of adhesive and then through a container of tobacco particles, such that tobacco particles adhere to the thread.

27. The method according to claim 23, wherein the method comprises using guide means to guide the thread as a tow of filter material is formed therearound.

28. The method according to claim 27, wherein the guide means comprises a guide tube through which the thread is entrained.

29. A thread comprising at least one piece of particulate tobacco adhered thereto.

30. The thread according to claim 29, wherein the thread has at least one tobacco particle adhered thereto, wherein the thread extends substantially longitudinally through a plug of filter material.

31. The filter element according to claim 1, wherein the thread is between 0.5 mm and 2 mm in diameter.

32. The filter element according to claim 9, wherein the tobacco particle has an average length of between 0.4 mm and 0.8 mm.

33. The filter element according to claim 1, wherein the diameter of the plug of filter material is between 8 mm and 10 mm.

34. A smoking article comprising the filter according to claim 17.
